(19) United States
(12) Patent Application Publication
(10) Pub. No.: US 2016/0151127 A1
(43) Pub. Date: Jun. 2, 2016

(54) DENTAL IMPLANT SCREW AND INSTALLATION TOOLS WITH OFFSET DRIVE ANGLE

(71) Applicant: EVOLLUTION IP HOLDINGS, INC., Birmingham, AL (US)

(72) Inventors: Boris Andres SIMMONDS, Vestavia, AL (US); Fred J. MOLZ, IV, Birmingham, AL (US); John J. BELLANCA, Birmingham, AL (US)

(73) Assignee: EVOLLUTION IP HOLDINGS, INC., Birmingham, AL (US)

(21) Appl. No.: 14/953,935

(22) Filed: Nov. 30, 2015

Related U.S. Application Data
(60) Provisional application No. 62/085,751, filed on Dec. 1, 2014.

(51) Int. Cl. A61C 8/00

(52) U.S. Cl. CPC A61C 8/0068; A61C 8/0053; A61C 2008/0084

(57) ABSTRACT

A dental component including a universal joint. In one form, the invention relates to a cam screw for fastening a temporary tooth to an implant including a driving component, a sleeve socket and an abutment screw. The driving component extends along a first axis and includes an internal hex opening for removably coupling the standard hex driving tool. The sleeve socket is provided for pivotally coupling to a portion of the driving component. The abutment screw extends along a second axis and portion thereof pivotally couples to the sleeve socket. With the first axis being offset at an angle relative to the second axis, the driving component is configured to provide torque to the abutment screw such that rotary movement about the first axis in turn causes rotary movement about the second axis.

### CROSS-REFERENCE TO RELATED APPLICATION

This application claims the benefit of U.S. Provisional Patent Application Ser. No. 62/085,751 filed Dec. 1, 2014, the entirety of which is hereby incorporated by reference herein.

### TECHNICAL FIELD

The present invention relates generally to the field of dental implants and prosthetics, and more particularly to a dental component having a universal joint incorporated therewith for providing a drive angle that is offset from a torque receiving axis.

### BACKGROUND

Dental implants are used to provide a platform to which a dental prosthesis may be secured to underlying bone in the mandible or maxilla of a human or animal dental patient. A typical root form dental implant system employs a dental implant that is placed and engaged in a prepared site in the underlying bone. Typically, after the implant is engaged in the site, a healing abutment or cover screw is affixed to the top of the implant and the bone surrounding the prepared site is allowed to grow into and/or around the implant for several months, thereby securing the implant to the bone. In some cases, an abutment is secured to the implant and a healing cap or temporary prosthesis is cemented to the abutment, all while the bone surrounding the prepared site is growing into and/or around the implant, and soft tissue heals.

Typically, a temporary prosthesis will be secured to the implant by using an abutment screw. The temporary prosthesis typically includes a screw channel formed therein for permitting a portion of the abutment screw to pass therethrough so that the abutment screw can secure the temporary prosthesis to the implant. It is typically desired that the screw channel of the temporary prosthesis be positioned to extend through the lingual (interior) portion of the tooth rather than the facial (exterior) portion, for example, to hide the tooth's attachment to the base and appear from outside of the mouth as though it is a final restoration. For proper attachment of the tooth to the implant, the abutment is precisely tightened to between about 10-35 Ncm (Newton centimeter) by using a torque wrench. In many cases, the torque wrench and the driver attached thereto (connecting to the head of the abutment screw) have been known to be limited in accessing the screw channel of the temporary prosthesis (and the head of the screw therein) when it is formed on a lingual portion thereof and having a drive angle that is angularly offset relative to the implant axis.

Accordingly, it can be seen that needs exist for an abutment screw for use with temporary teeth or abutments, especially those that have the screw channel being formed through the lingual portion and having a drive angle that is angularly offset relative to the implant axis. Needs also exist for dental implements and tools for torque transmission at offset drive angles. It is to the provision of a dental implant screw, dental implements and tools for torque transmission at offset drive angles meeting these and other needs that the present invention is primarily directed. In further example forms, it is to the provision of a dental implant screw with a cam-sleeved drive head for installation in an abutment mount with the drive angle being offset from the axis of the screw meeting these and other needs that the present invention is primarily directed.

### SUMMARY

In example embodiments, the present invention provides a cam screw for coupling a temporary tooth to an implant. The cam screw includes a universal joint such the drive angle of the screw can be offset from the axis of the screw. In further example embodiments, the present invention provides a dental implant screw, dental implement and/or tool for torque transmission at offset drive angles in dental implant applications.

In one aspect, the invention relates to a cam screw including a driving component, a sleeve socket, and an abutment screw. The driving component includes an internal hex opening and a ball portion positioned generally below the driving component. In example forms, the driving component and the ball portion generally extend along an elongate first axis. The ball portion includes a pair of outer radial lobes and a central radial cam surface positioned therebetween, the radial lobes being positioned along a first pivot axis. The sleeve socket includes an interior portion and an exterior portion, the interior portion having a pair of radial pockets and a central radial cam surface positioned therebetween. The exterior portion includes a pair of outer radial lobes and an outer radial cam surface positioned therebetween, the radial pockets of the interior portion being positioned along a second pivot axis and the radial lobes on the exterior portion being positioned along a third pivot axis, with the second and third pivot axes being generally transverse relative to one another. The abutment screw generally extends along an elongate second axis and includes a lower threaded portion, an upper head portion, and a medial portion positioned therebetween. The upper head portion includes an outer socket having a pair of radial pockets and a central radial cam surface formed therein, the central radial cam surface being positioned between the radial pockets, and the radial pockets being positioned along a fourth pivot axis.

In example forms, the ball portion of the driving component removably couples to the interior portion of the sleeve socket such that the driving component is pivotable relative to the sleeve socket in a first direction but prohibited from pivoting in a second direction generally transverse to the first direction. The exterior portion of the sleeve socket removably couples to the outer socket of the upper head portion of the abutment screw, the sleeve socket being pivotable relative to the outer socket in a third direction but prohibited from pivoting in a fourth direction generally transverse to the third direction. The first direction is substantially similar to the fourth direction. The second direction is substantially similar to the third direction.

In another aspect, the invention relates to a cam screw for fastening a temporary tooth to an implant, wherein the cam screw is being driven within the implant by a standard hex driving tool. The cam screw includes a driving component extending along a first axis and including an internal hex opening for removably coupling the standard hex driving tool, a sleeve socket for pivotally coupling to a portion of the driving component, and an abutment screw extending along a second axis and portion thereof pivotally coupling to the sleeve socket. Preferably, with the first axis being offset at an angle relative to the second axis, the driving component is configured to provide torque to the abutment screw such that rotary movement about the first axis in turn causes rotary movement about the second axis.

In still another aspect, the invention relates to a method of torque application using a dental implement such as an implant screw having a driving angle that is offset at an angle relative to the axis of the screw. The method generally includes providing a driving component, the driving component extending along a first axis and having an internal hex opening and a ball portion positioned generally below the internal hex opening; providing a sleeve socket, the sleeve socket having an interior portion and an exterior portion, the interior portion being configured for pivotally coupling to the ball portion; and providing an abutment screw, the abutment screw extending along a second axis and having a lower threaded portion and an upper head portion, the upper head portion having an outer socket, the outer socket configured for pivotally coupling to the exterior portion of the sleeve socket; pivotally coupling the ball portion to the interior portion of the sleeve socket; pivotally coupling the exterior portion of the sleeve socket to the outer socket of the abutment screw, wherein with the first axis being offset and an angle relative to the second axis, the driving component is capable of applying torque about the first axis in a first direction to cause torque to be applied to the abutment screw about the second axis in the first direction.

In another aspect, the invention relates to a dental component including a driving member, a spherical member and a torque receiving member. The driving member includes a generally elongate member having a first end and a second end. The first end includes an engagement portion and the second end includes a clip. Preferably, the driving member is rotatable about a torque delivery axis. The spherical member includes first and second channels generally extending around the entirety of the circumference of the spherical member and wherein the channels are generally positioned transverse relative to each other. The torque receiving member includes a first end and a second end. The first end includes a clip and the second end includes an engagement portion. Preferably, the torque receiving member is rotatable about a torque receiving axis.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description are exemplary and explanatory of preferred embodiments of the invention, and are not restrictive of the invention, as claimed.

### BRIEF DESCRIPTION OF THE DRAWINGS

FIG. 1 is a perspective view of a cam screw according to an example embodiment of the present invention.

FIGS. 2-5 are additional views of the cam screw of FIG. 1.

FIG. 6 is a perspective view of driving component of the cam screw of FIG. 1.

FIGS. 7-11 are additional views of the driving component of the cam screw of FIG. 6.

FIG. 12 is a perspective view of a sleeve socket of the cam screw of FIG. 1.

FIGS. 13-18 are additional views of the sleeve socket of FIG. 12.

FIG. 19 is a perspective view of the abutment screw of FIG. 1.

FIGS. 20-23 are additional views of the abutment screw of FIG. 19.

FIG. 24 shows a sequence of torque application and rotation of the cam screw according to an example embodiment of the present invention, the driving component being offset at an angle relative to the abutment screw.

FIG. 25 shows a partial cross-sectional view of the cam screw employed within an abutment and a restorative prosthesis.

FIGS. 26-27 shows a universal joint according to another example embodiment of the present invention.

FIGS. 28-29 show a cam screw comprising a ball joint according to another example embodiment of the present invention.

FIG. 30 shows a dental component in the form of a driver having a ball joint according to another example embodiment of the present invention.

FIG. 31 shows a dental component in the form of a drill component having a ball joint according to another embodiment.

### DETAILED DESCRIPTION OF EXAMPLE EMBODIMENTS

The present invention may be understood more readily by reference to the following detailed description taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

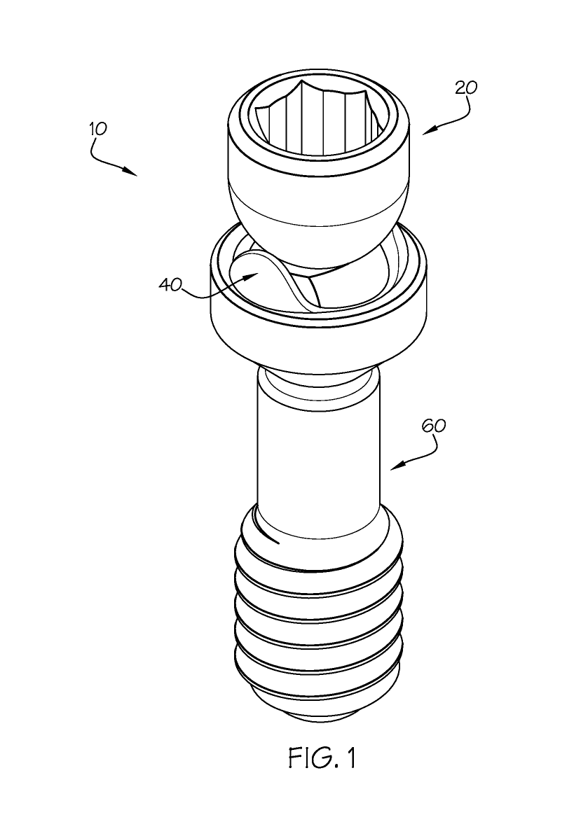

With reference now to the drawing figures, wherein like reference numbers represent corresponding parts throughout the several views, FIG. 1 shows a cam screw 10 according to an example embodiment of the present invention. In example embodiments, the cam screw 10 is generally used for dental applications, for example, to removably secure a restorative tooth to an implant (e.g., as in an abutment screw). Preferably, a universal joint is incorporated with the cam screw 10 to provide for driving (tightening/loosening) the screw at an angle (e.g., driving angle) that is offset from an axis of the screw. In one example form, the cam screw 10 enables the restorative tooth to have an angulated screw channel on an interior or lingual portion thereof (less visible location on the restorative tooth), whereby the practitioner can adjust the driving angle of the cam screw to provide for applying torque to the screw to safely and precisely drive and secure the cam screw to the implant, thereby safely and securely securing the restorative tooth to the implant. Optionally, the cam screw 10 can be used in other applications such as orthopedics or other medical applications, for example, where the driving angle can be offset at an angle relative to the screwing axis. Further optionally, the cam screw 10 or at least the universal joint thereof can be used in other devices or functions such as delivering torque at an angle (drive shafts), high-speed applications (contra-angle surgical hand-piece/motor), fasteners (screws/bolts) for use with standard drivers, or drivers (screwdrivers and extension accessories) for use with standard fasteners, for example in dental, orthopedic or other surgical applications.

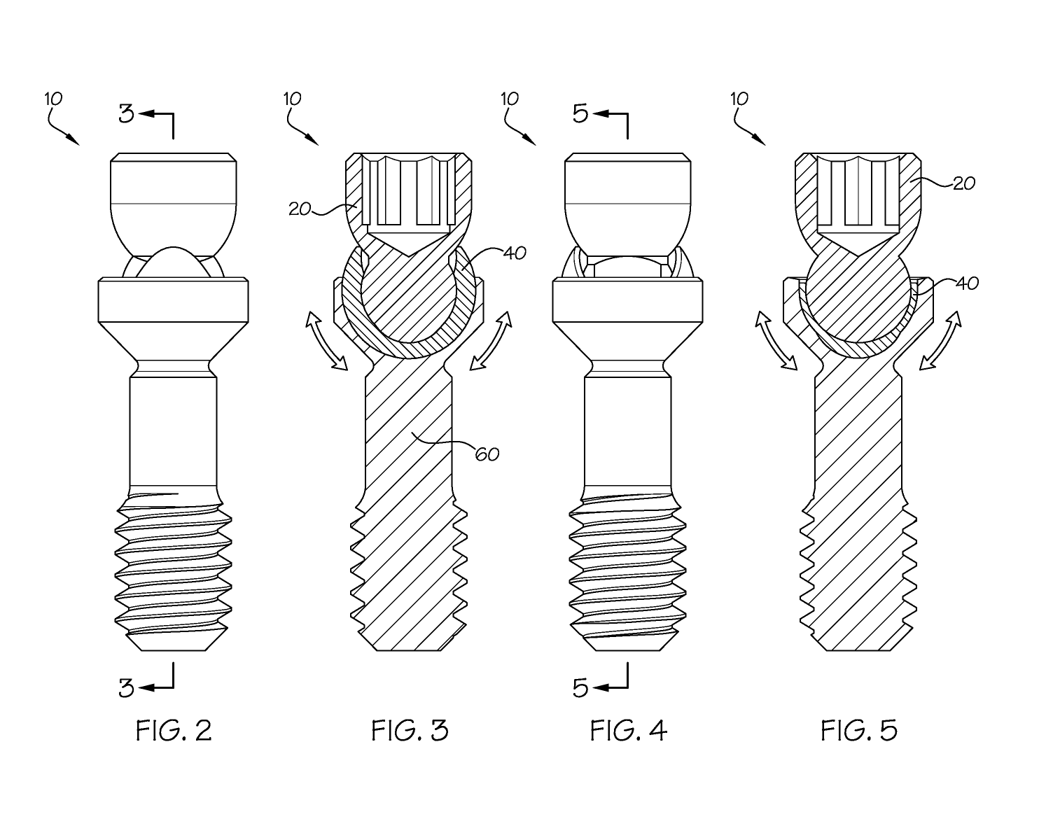

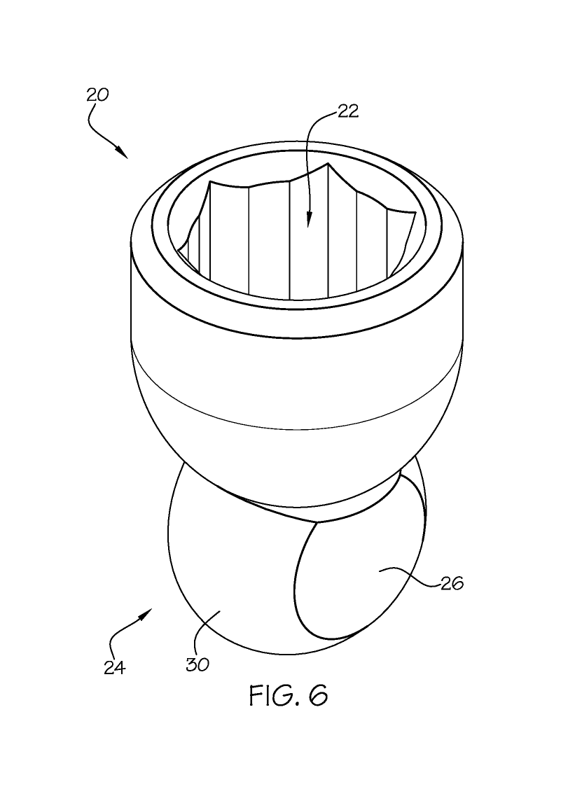

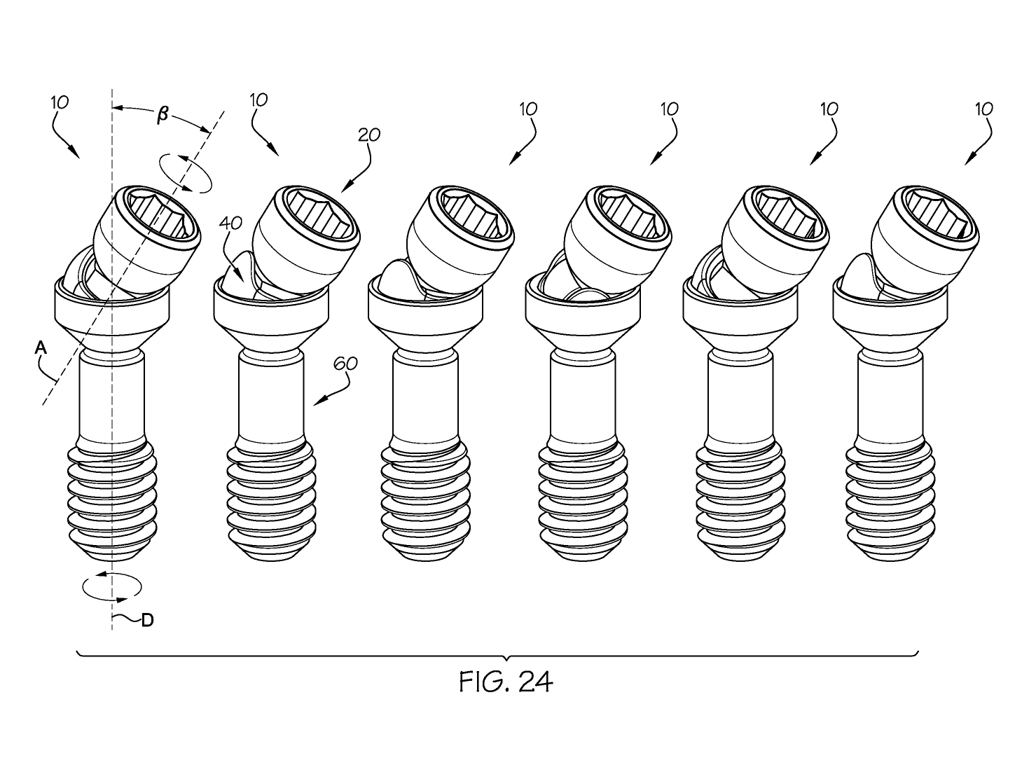

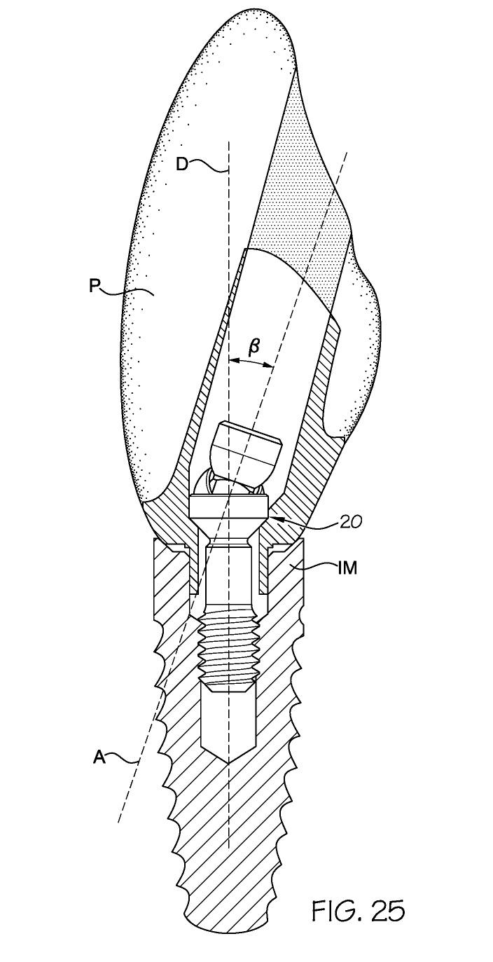

Referring to FIGS. 1-5, the cam screw 10 generally comprises a driving component or element 20, a sleeve socket or eccentric sphere 40, and an abutment screw 60. Generally, a portion of the driving component 20 is fitted or movably mounted within the sleeve socket 40 and the sleeve socket 40 is fitted or movably mounted within a portion of the abutment screw 60. As shown in FIGS. 2-3, when viewed from a first side and the cross-section (F-F) thereof, the sleeve socket 40 (and driving component 20 movably mounted therein) is capable of pivoting in a first and second pivotal direction relative to the abutment screw 60. Similarly, as shown in FIGS. 4-5, when viewed from a second side and the cross-section (G-G) thereof, the driving component 20 is capable of pivoting in a third and fourth pivotal direction relative to the sleeve socket 40 (and abutment screw 60 coupled thereto). Thus, as will be described below, with the driving component 20 being offset at an angle relative to an axis of the abutment screw 60 (see FIGS. 24-25), a driving tool or instrument can preferably apply torque to the driving head 20, through the sleeve socket 40, and to the abutment screw 60 to couple the abutment screw to the implant.

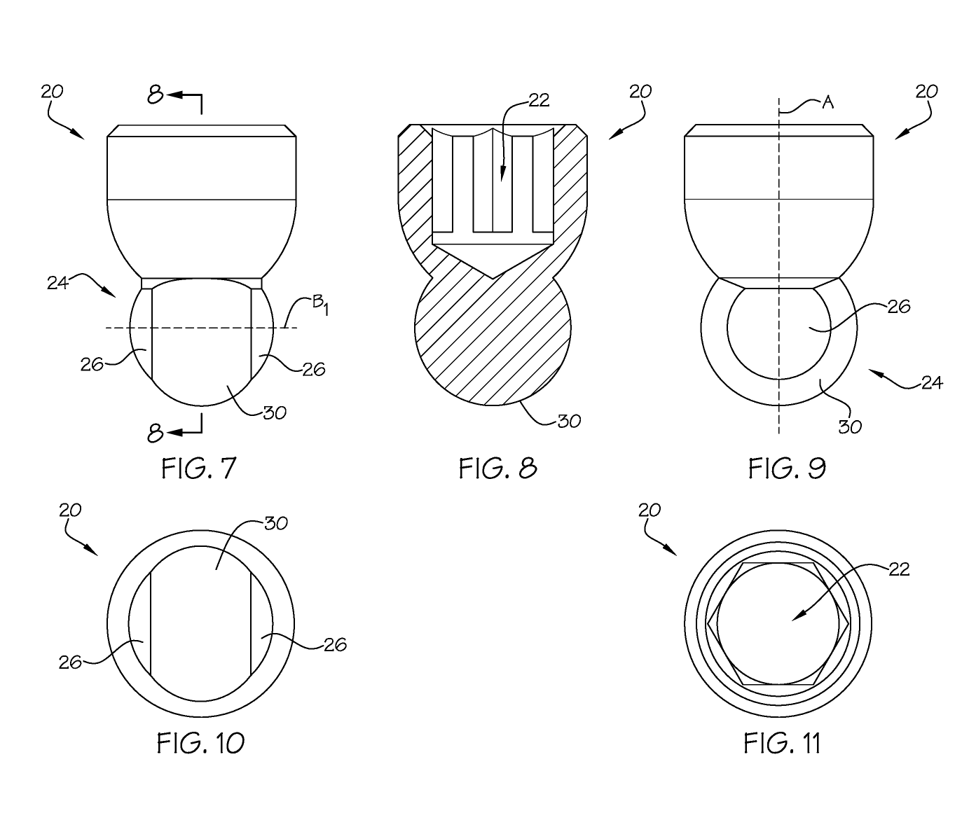

FIGS. 6-11 show the driving component 20 in greater detail. As depicted, the driving component 20 generally comprises an upper portion comprising an internal hex opening 22 and an eccentric bulb or ball portion 24 generally positioned below the upper portion. Generally, the internal hex opening 22 and the ball portion 24 extend along an elongate central axis A. In preferred forms, the internal hex opening 22 and the ball portion 24 are integrally connected together. Optionally, the ball portion 24 is removably coupled to the hex opening 22, for example, by snap-fit, threads, pins, clips, etc. Preferably, the internal hex opening 22 is provided for receiving a standard hex driver or instrument to affix and remove the cam screw 10 to/from the implant that is installed within a patient's mouth. In preferred forms, the internal hex opening 22 is preferably configured to provide removable engagement with the standard hex driver, for example, to prevent the screw from falling in the patient's mouth and causing aspiration. In one example form, the internal hex opening 22 is sized to be substantially similar to the size of the hex driver such that the contact area increases and thereby provides additional friction therebetween to prevent a less forceful disengagement. For example, in one example form, the sizes are configured such that a force of between about 1-5 lbs in any direction (acting on the cam screw 10) is required to disengage the cam screw from the hex driver. Optionally, the sizes of the internal hex opening 22 and the hex driver are such that about 2.5 lbs of force is required for disengagement therefrom. Optionally, a spring biased ball bearing or other component can be coupled to an internal portion of the hex opening 22 to provide engagement with the standard hex driver, for example, to maintain engagement therebetween.

In example forms, the ball portion 24 comprises a pair of outer radial lobes 26 and a central radial cam surface 30. Typically, the outer radial lobes 26 are positioned on opposite sides of the central radial cam surface 30 and are generally axially aligned with an axis B₁, which is generally oriented transverse axis A. Preferably, as will be described below, the outer radial lobes 26, which are fitted within the sleeve socket 40, allow for pivoting of the driving component 20 relative to the socket sleeve 40 about an axis B₂.

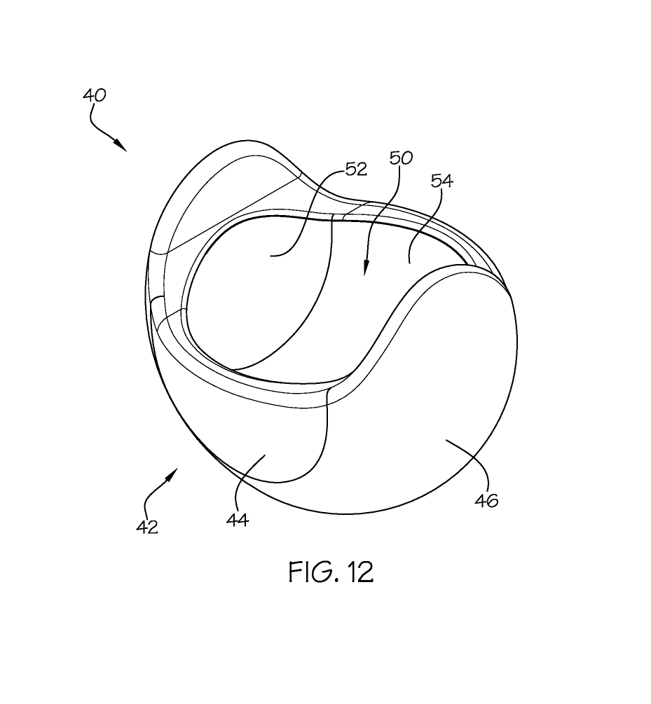

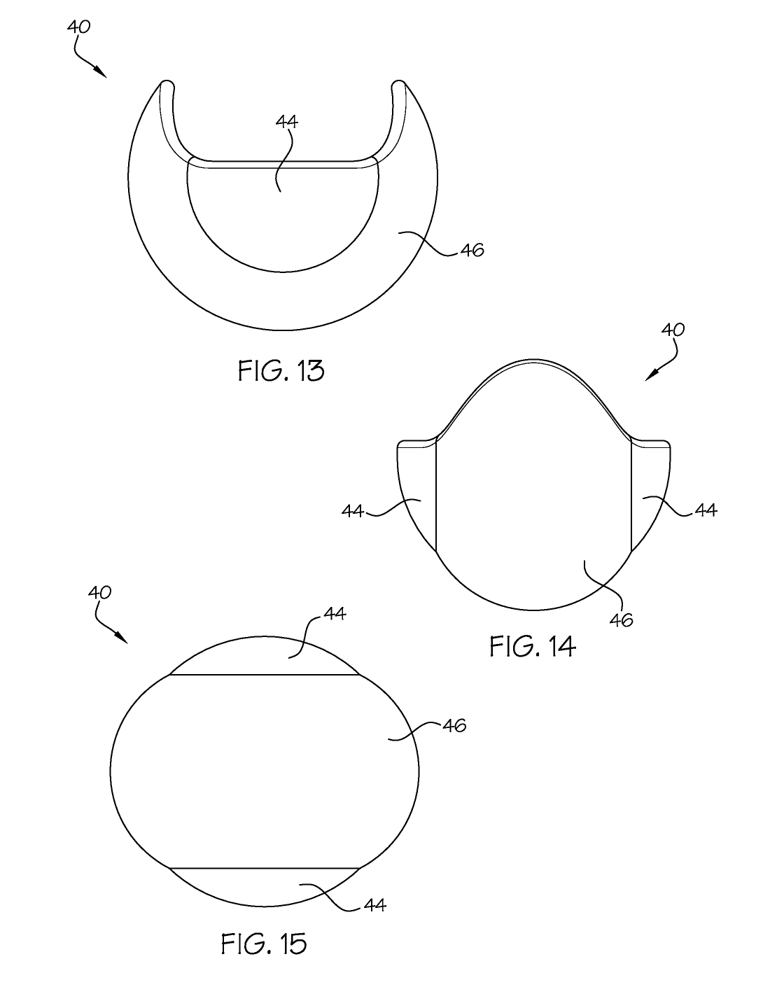

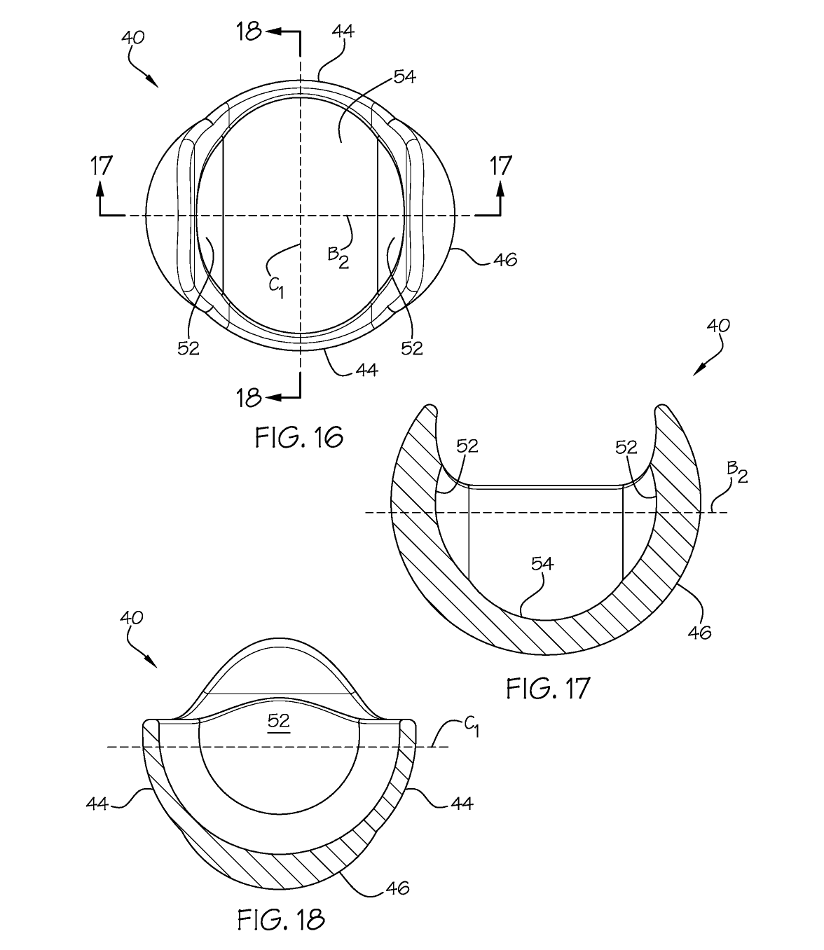

FIGS. 12-18 show the sleeve socket 40 in greater detail. As depicted, the sleeve socket 40 generally comprises an exterior portion 42 and an interior portion 50. In example forms, the exterior portion 42 and the interior portion 50 are generally shaped similarly to the ball portion 24 of the driving component 20 and a portion of the abutment screw 60 (as will be described below), for example to provide for movably mounting the components together. In one example form, the interior portion 50 comprises a pair of oppositely-positioned radial pockets 52 and a central radial cam surface 54. Generally, the radial pockets 52 are axially aligned along the axis B₂. Preferably, the size and shape of the radial pockets 52 and the cam surface 54 are substantially similar or slightly larger than the radial lobes 26 and central radial cam surface 30 of the ball portion 24, for example, such that the ball portion 24 can movably mount to the interior portion 50 of the sleeve socket 40. As such, the outer radial lobes 26 are preferably configured to couple within the radial pockets 52 and the central radial cam surface 30 is configured to couple or movably mount against the central radial cam surface 54. Thus, when the ball portion 24 is movably mounted within the interior portion 50 of the sleeve socket 40, the axis B₁ is preferably axial with the B₂ whereby the driving component 20 is pivotable relative to the sleeve socket 40 about the collinear axes B₁, B₂.

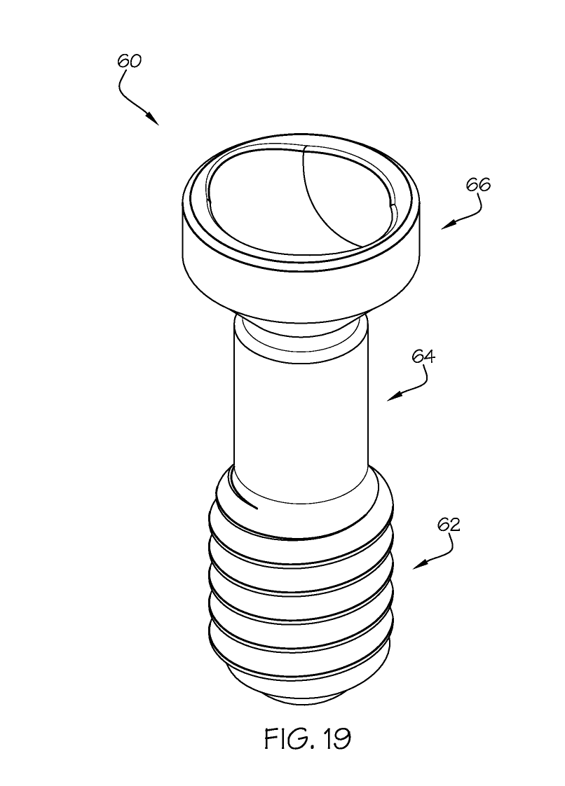

Similarly, the exterior portion 42 of the sleeve socket 40 comprises a pair of oppositely-positioned outer radial lobes 44 and a centrally-positioned outer radial cam surface 46. As shown in FIG. 18, the outer radial lobes 44 are axially aligned along an axis C₁, which is generally oriented transverse to the axis B₂ of the radial pockets 52 of the interior portion 50. The outer radial cam surface 46 is positioned between the outer radial lobes 44 and comprises a pair of tip ends or ears 47, which generally extend upwards above the elevation of the outer radial lobes 44. In one form, the tip ends 47 are generally radiused to provide a smooth transition between the outer radial lobes 44.

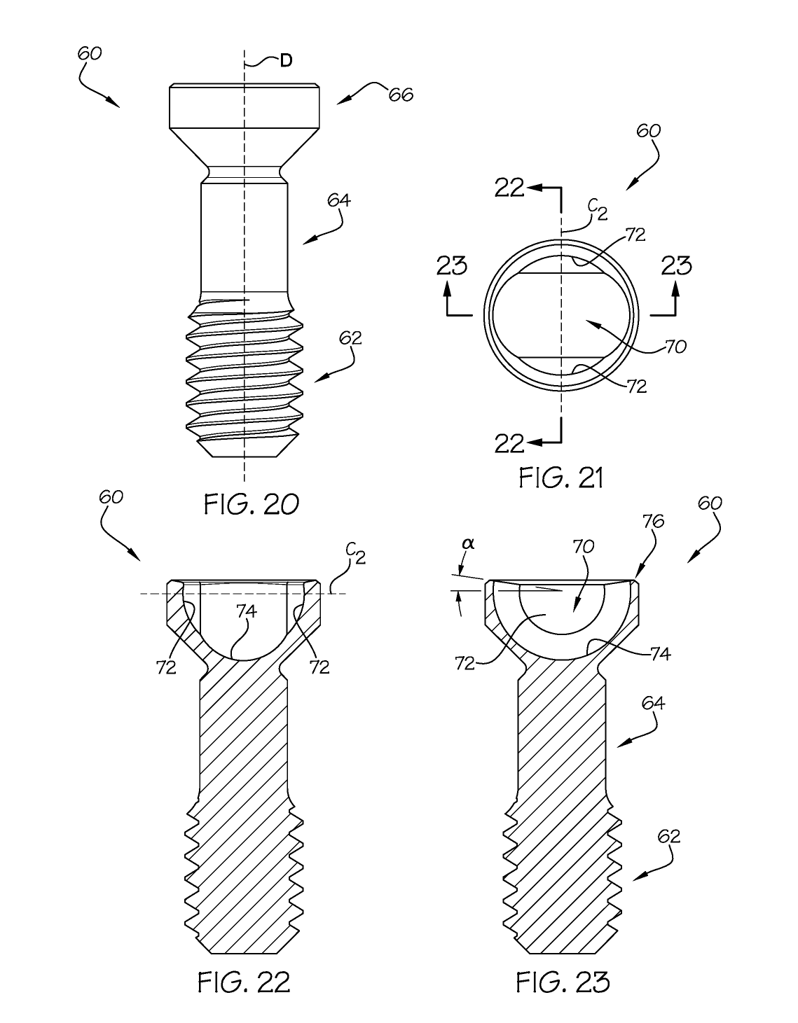

FIGS. 19-23 show an example embodiment of the abutment screw 60 in greater detail. As depicted, the abutment screw 60 generally comprises a generally elongate member extending along an axis D having a lower threaded portion 62, a medial cylindrical portion 64, and an upper head portion 66. Preferably, the threaded portion 62 comprises a thread pattern that corresponds to the thread pattern of an internal thread portion of the implant or other screw-receiving member, thus ensuring interengagement therebetween. In example forms, the upper head portion 66 generally forms a conical-shaped head and comprises an outer socket 70 formed therein. The conical or angled portion of the upper head portion 66 is preferably configured to match up with the implant system, for example, such that the cam screw 10 is sufficiently seated within the implant and wherein the conical portion is in contact with a portion of the restorative tooth. The outer socket 70 preferably comprises a pair of radial pockets 72 and a central radial cam surface 74, which are shaped similarly to the outer radial lobes 44 and the outer radial cam surface 46 of the sleeve socket 40. Typically, the radial pockets 72 are generally positioned opposite from each other on either side of the central radial cam surface 74 and are axially aligned along an axis C₂.

Preferably, the central radial cam surface 74 is sized to receive and provide sliding engagement with the outer radial cam surface 46 of the exterior portion 42 of the sleeve socket 40. Similarly, the radial pockets 72 are preferably sized to receive and provide pivotal engagement with the outer radial lobes 44 of the exterior portion 42 of the sleeve socket 40. As such, when the exterior portion 42 of the sleeve socket 40 is movably mounted within the outer socket 70 of the upper head portion 66, the axis C₁ of the outer radial lobes 44 is axial and collinear with the axis C₂ of the radial pockets 72, thereby allowing pivotal movement of the sleeve socket 40 relative to the outer socket 70 and with the outer radial cam surface 46 slidingly engaging the central radial cam surface 74.

As shown in FIG. 23, the radial pockets 72 and the central radial cam surface 74 are preferably formed and positioned within the outer socket 70 such that a lip or upper portion 76 thereof, which generally defines the upper end of the outer socket 70, extends above the axis C₂ to define an angle α. For example, the lip 76 preferably provides that the arc length of the central radial cam surface 74 exceeds 180 degrees by the angle α relative to the axis C₂ (or the horizontal plane wherein the angle of the arc length of the central radial cam surface is 180 degrees) so that the sleeve socket 40 is provided with a press-in fit when coupled to the outer socket 70. In example forms, the angle α is between about 2-10 degrees. In preferred example embodiments, the angle α is about 5 degrees. Preferably, the lip 76 and angle α defined thereby are configured to ensure the sleeve socket 40 (and the ball portion 24 fitted therein) are provided with a secure yet movable fit such that the sleeve socket 40 remains engaged with the outer socket 70 but allows for pivotal motion thereof such that the driving component 20 can be offset at an angle relative to the axis D of the abutment screw 60 to drive and fasten/remove the cam screw 10 to/from the implant.

FIG. 24 shows a sequence of torque application and rotation of the cam screw 10 according to an example embodiment of the present invention. As depicted, the driving component 20 is rotating in a counter-clockwise direction along the axis A, which causes the abutment screw 60 to rotate in a counter-clockwise direction along the axis D. Thus, torque being applied to the driving component 20 in either a clockwise or counter-clockwise rotational direction about axis A directly results in the same clockwise or counter-clockwise rotational torque being applied to the abutment screw 60 about axis D. In example forms, axis D is generally offset or angled at an angle β relative to axis A of the driving component 20. According to one example form, the angle β is generally between about 1-60 degrees. In another example form, the angle β is between about 25-45 degrees, more preferably between about 30-40 degrees. In example forms, the universal joint including the ball portion of the driving component, the sleeve socket, and the upper head portion of the abutment screw, or shapes, functions, etc. thereof, preferably is constant velocity such that it is capable of transmitting torque at a variable angle, at a constant rotational speed, and without appreciable increase in friction or play.

FIG. 25 shows an example of the cam screw 10 being used to secure a prostheses P to an implant IM. As depicted, the axis D is generally axially aligned within the bore of the implant and comprises internal threads for interengaging the lower threaded portion 62 of the abutment screw 60. In example forms, the prosthesis P comprises a screw channel C extending out of a lingual portion of the prosthesis P. As such, the driving component 20 is angled such that the axis A is generally axial with the screw channel C (and offset at the angle β relative to the axis D), whereby a standard hex driver or other torque application device is capable of accessing the driving component and applying torque thereto, and wherein the torque being applied thereto is further transferred through the universal joint (pivots and cam surfaces) and to the abutment screw for securing the prosthesis P to the implant IM.

In example embodiments, the driving component 20, the sleeve socket 40 and the abutment screw 60 are preferably manufactured separately and assembled together to form the cam screw 10. The components 20, 40, 60 can be formed by machining, injection molding, 3D printing, casting, or other desired manufacturing techniques as desired. Optionally, the driving component 20, the sleeve socket 40, and the abutment screw 60 can be manufactured together but still allow for movement therebetween such that the angle of the axis of the driving component can be adjusted relative to the axis of the abutment screw. In one example form, the driving component 20 and the abutment screw 60 are formed from a titanium alloy (e.g., Ti-6 Al-4V) and the sleeve socket 40 is formed from a high temperature plastic material (e.g., PEEK). Optionally, one or more of the components can be formed from other materials including ceramic, zirconium, other alloys, other medical-grade plastics/composites or metals, or other materials as desired.

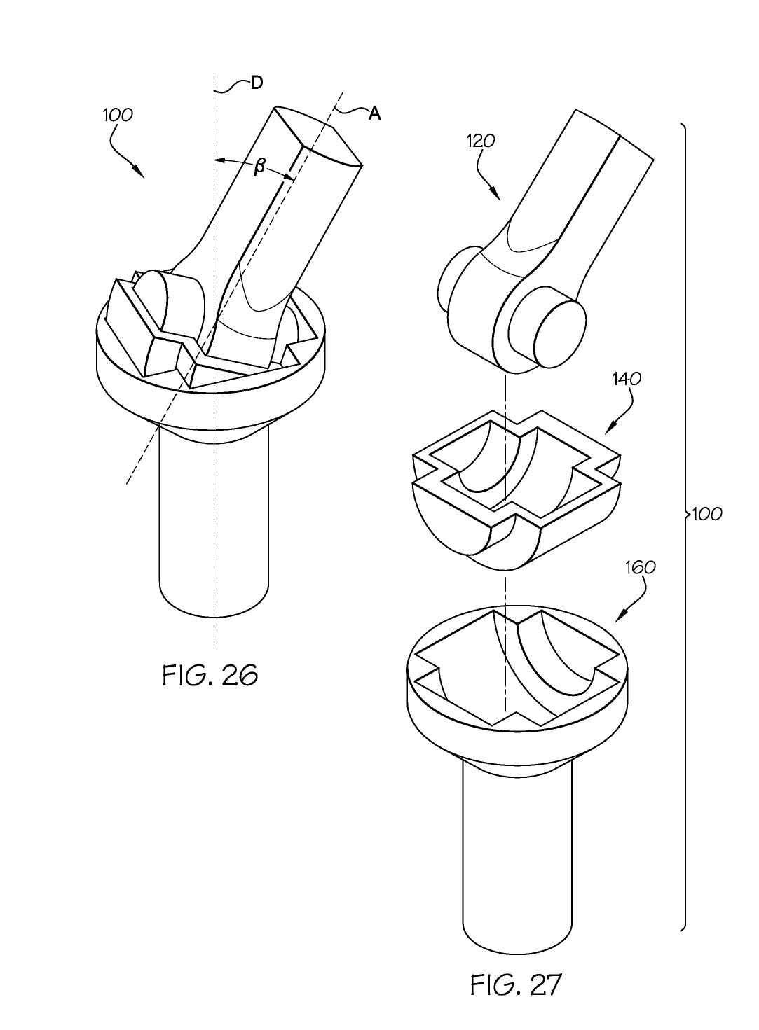

In additional example embodiments, the components of the universal joint can be shaped as desired to provide pivotal or other movement therebetween when coupled together. For example, the lobes, recesses or pockets, and the radial cam surfaces can be other shapes including generally squared cylinders, other radial shapes, spherical, etc. For example, as depicted in FIGS. 26-27, a universal joint 100 is comprised of a driving or torque delivery member 120, an intermediate sleeve 140, and a torque receiving member 160, which generally comprises squared cylinders or recesses, and which are generally provided to function similarly as described above. Optionally, other shapes may be provided as desired.

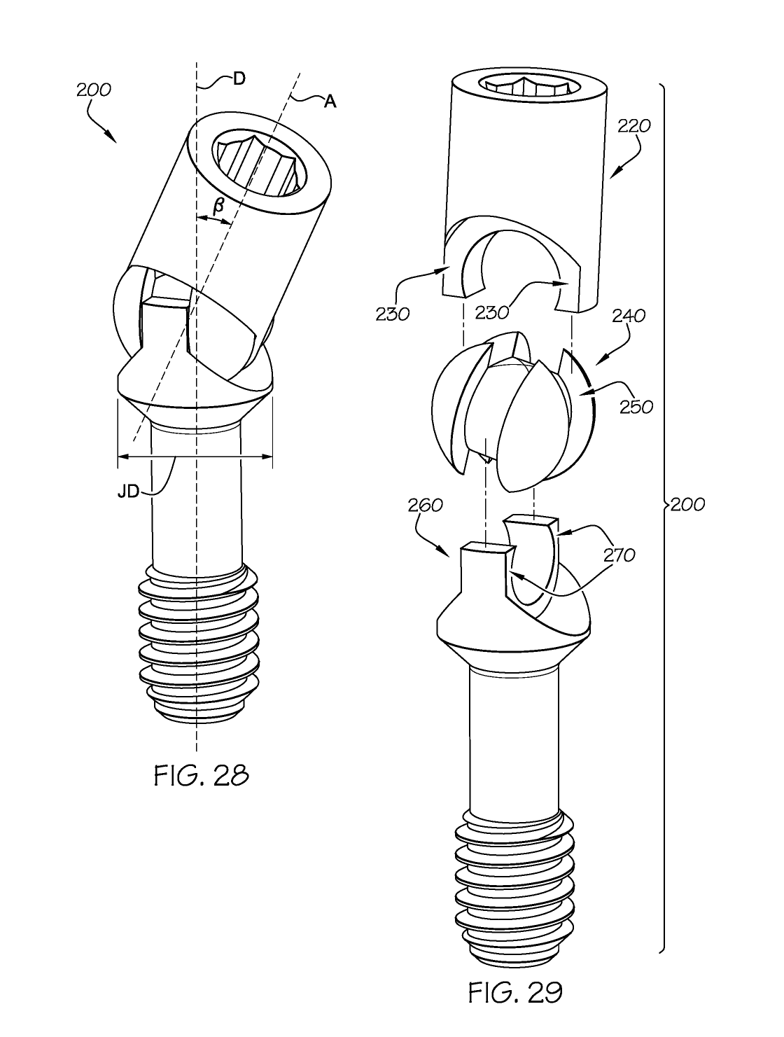

FIGS. 28-29 show a cam screw 200 comprising a universal joint according to another example embodiment of the present invention. As depicted, the cam screw 200 comprises a driving member 220, a central connector ball or spherical member 240, and an abutment screw 260. In example forms, the driving member 220 comprises a rod-like member having an internal hex opening at a first end and a C-shaped clip or radiused fingers 230 extending therefrom at a second end. The spherical member 240 generally comprises a solid sphere-shaped member comprising ring-like channels 250 generally positioned perpendicular relative thereto. The abutment screw 260 comprises a rod-like member having a first end comprising a similar C-shaped clip (having fingers 270 extending therefrom), a medial portion, and a threaded portion extending to a second end thereof. Preferably, the fingers of the clips generally comprise a radiused and substantially smooth surface that is sized t substantially conform to the surface defined by the channels 250 of the spherical member 240. Preferably, the clip at the second end of the driving member movably couples to one of the ring-like channels 250 of the spherical member and the clip at the first end of the abutment screw 260 (and fingers 270 thereof) movably couple to the other ring-like channel 250. As such, with the driving component being offset at an angle β relative to an axis of the abutment screw (see FIG. 24), a driving tool or instrument can preferably provide torque to the driving component 220, through the spherical member 240, and to the abutment screw 260 to couple the abutment screw 200 to the implant. Optionally, the spherical member and the clips can be shaped, sized and/or formed as desired. In one example form, the driving component, the spherical member and the abutment screw are all formed from a titanium alloy material. Optionally, the spherical member 240 is formed from a high temperature plastic material. Optionally, one or more of the components can be formed from other materials including ceramic, zirconium, other alloys, other medical-grade plastics/composites or metals, or other materials as desired.

According to further example forms, the cam screw 200 (and other screws, joints, etc. as described herein) generally comprise a joint diameter JD. In example forms, the cam screw 200 (or joint thereof including other embodiments as described herein) comprises a maximum joint diameter JD of about 0.100 inches and is capable of transmitting a minimum torque of about 30 N·cm. Thus, the cam screw 200 is generally capable of transmitting a minimum torque of about 30 N·cm with the joint diameter JD thereof being a maximum of about 0.10 inches. For example, according to some example forms, the cam screw is entirely formed from a titanium alloy material having a joint diameter of about 0.09 inches while supporting a torqued load being applied to the cam screw 200 of between about 30-35 N·cm. Optionally, the spherical member 240 is formed from a high temperature plastic material and the joint diameter JD is about 0.100 inches, for example, such that the cam screw is capable of transmitting a minimum torque of about 30 N·cm. Optionally, as one of ordinary skill in the art would appreciate, one or more of the components can be formed from other materials including ceramic, zirconium, other alloys, other medical-grade plastics/composites or metals, or other materials as desired.

According to some example forms, the spherical member 240 is generally permanently and movably attached to either one of the driving component 220 or the abutment screw 260, and the other one of the driving component 220 or abutment screw 260 is generally removably engagable with the spherical member 240 such that torque may be transferred from the driving member 220, through the spherical member 240, and to the abutment screw 260. Thus, according to some example forms, the universal joint is generally separable yet removably engagable to provide for transferring torque through the universal joint as desired, for example, wherein the driving component is generally rotatable about a torque delivery axis A and the abutment screw is generally rotatable about a torque receiving axis D, and wherein the torque delivery axis A is generally offset at an angle β relative to the torque receiving axis D. Thus, according to some example forms, the spherical member 240, the driving component 220 and the abutment screw 260 are generally not constrained to remain movably engaged with each other, for example, whereby one of the driving component 220 or the abutment screw 260 can be removably engagable with the spherical member 240 such that the cam screw 200 can be separated into two pieces and whereby they can become movably engaged together when torque is desired to be transmitted.

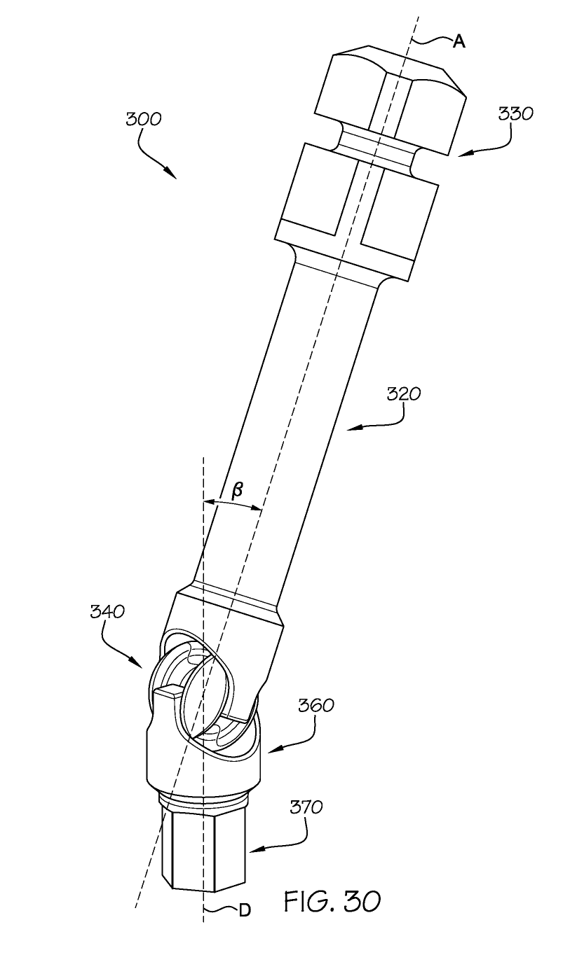

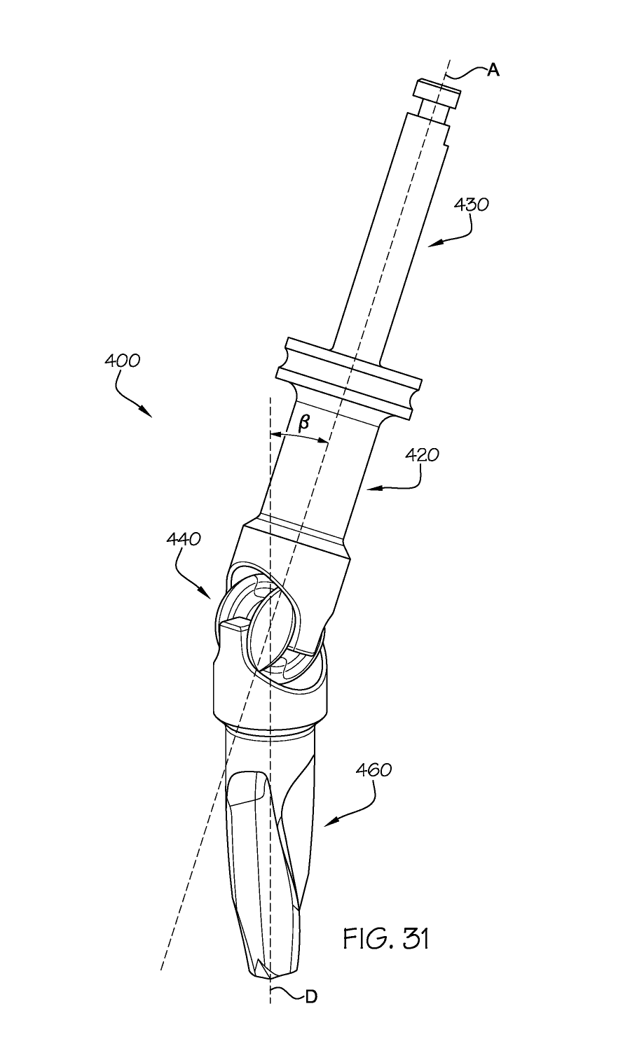

In additional example embodiments of the present invention, other dental components, tools or implements for application or delivery of torque at an angularly offset drive angle comprise a universal joint substantially as disclosed herein, whereby the torque delivery axis A is generally offset at an angle relative to the torque receiving axis D. According to example forms, dental components which may be provided with the universal joint can be in the form of a drill, a driver, or a joint, for example, which is generally defined between the driver and the screw, or which may be defined between the driver and the drill. For example, as depicted in FIG. 30, a driver 300 may be provided with a universal joint such that the torque delivery axis A is generally offset at an angle relative to the torque receiving axis D. In example forms, the driver 300 comprises a generally elongate torque delivery member or driving member 320 having an engagement portion 330 (to be received by a drill device or rotary tool) and a C-shaped clip having fingers extending therefrom; a generally spherical member 340 comprising a pair of channels generally oriented perpendicular relative to each other (e.g., similar to spherical member 240); and a torque receiving member 360 comprising a C-shaped clip having fingers extending therefrom and a male engagement member or hex member 370 for fitting within a complementary-shaped female hex receiver, such as the female hex receiver of an abutment screw. As such, with the engagement portion 330 engaged with the drill device and driving the driving member 320 in a rotational direction about the torque delivery axis A, the torque receiving member 360 is forced to rotate in the same direction. Preferably, the torque receiving member 360 is capable of transmitting a minimum torque of about 30 N·cm. Alternatively, as depicted in FIG. 31, the universal joint can be incorporated with a drill 400, for example, which generally comprises a driving member 420 (generally similar to the driving member 320 of the driver 300), a spherical member 440, and a drill bit 460. According to example forms, the joint diameter JD is generally about 0.100 inches and the diameter of the bit 460 can be scaled to a diameter that is generally between about 1/32-2 times size of the joint diameter JD. Thus, according to example forms, the diameter of the bit 460 can be sized to be between about 0.003125-0.200 inches with the joint diameter being at about 0.100 inches.

According to example forms, the C-shaped clips (of the driving member 220, 320, 420 and the abutment screw/torque receiving member 260, 360, 460) and the arc length thereof that is defined between the ends of the fingers exceeds 180 degrees by an angle of between about 2-10 degrees, more preferably 4-6 degrees, for example, so that the C-shaped clips are provided with a press-in fit when coupled to the channels of the spherical member 240, 340, 440. According to preferred forms, a lip, which is generally defined between a horizontal plane positioned at the center of clip and the ends of the fingers that are positioned at an angle relative to the horizontal plane, for example, as similarly described with respect to FIG. 23, ensures that the C-shaped clips are provided with a secure yet movable fit with the channels of the spherical member 240, 340, 440. Thus, the driving member 220, 320, 420 and the abutment screw/torque receiving member 260, 360, 460 remain engaged with the spherical member 240, 340, 440 but provide for pivotal movement therebetween such that the driving member 220, 320, 420 can be offset at an angle β relative to the axis D of the abutment screw/torque receiving member 260, 360, 460 to drive, fasten, drill, etc. the dental component. Alternatively, as described above, the screw 200, driver 300 and/or drill 400 may be configured such that the spherical member 240, 340, 440 is generally permanently and movably mounted to one of the driving member 220, 320, 420 or the abutment screw/torque receiving member 260, 360, 460, and the other of the driving member 220, 320, 420 or the abutment screw/torque receiving member 260, 360, 460 is generally removably engageable with the spherical member 240, 340, 440 such that the screw 200, driver 300 and/or drill 400 can be separated into at least two pieces or components, and whereby when torque is desired to be transmitted, the pieces can be removably mounted together to transmit torque.

According to additional example embodiments of the present invention, at least one pivot may be provided on the driver and at least one pivot is provided on the abutment screw or a portion of the overall screw assembly. In one form, a universal joint is incorporated with the driver and a universal joint is incorporated with the abutment screw. Optionally, the at least one pivot of the cam screw with the at least one pivot of the abutment screw, when coupled together, form a universal joint.

While the invention has been described with reference to preferred and example embodiments, it will be understood by those skilled in the art that a variety of modifications, additions and deletions are within the scope of the invention, as defined by the following claims.

What is claimed is:

1. A dental component comprising:
a driving member comprising a generally elongate member having a first end and a second end, the first end comprising an engagement portion and the second end comprising a clip, the driving member being rotatable about a torque delivery axis;
a spherical member comprising first and second channels generally extending around the entirety of the circumference of the spherical member, the channels generally being positioned transverse relative thereto; and
a torque receiving member comprising a first end and a second end, the first end comprising a clip and the second end comprising an engagement portion, the torque receiving member being rotatable about a torque receiving axis.

2. The dental component of claim 1, wherein the clip of the driving member generally pivotally couples to the first channel of the spherical member.

3. The dental component of claim 2, wherein the clip of the torque receiving member pivotally couples to the second channel of the spherical member.

4. The dental component of claim 3, wherein with the torque delivery axis being offset at an angle relative to the torque receiving axis, the driving member is capable of applying torque about the torque delivery axis in a first direction to cause torque to be applied to the abutment screw about the torque receiving axis in the first direction.

5. The dental component of claim 4, wherein the torque delivery axis can be offset at an angle relative to the torque receiving axis between about 1-60 degrees.

6. The dental component of claim 4, wherein the driving member, the spherical member and the torque receiving member, when assembled together, is capable of transmitting a minimum torque of about 30 N·cm.

7. The dental component of claim 6, wherein a ball joint is defined by the connection of the clips of the driving member and the torque receiving member pivotally coupled to respective first and second channels of the spherical member, and wherein the ball joint defines a joint diameter having a maximum dimension of about 0.100 inches.

8. The dental component of claim 7, wherein with the joint diameter having a maximum dimension of about 0.100 inches, the dental component is capable of transmitting a minimum torque of about 30 N·cm.

9. The dental component of claim 1, wherein the dental component comprises an abutment screw wherein the driving member comprises an internal female hex receiver and the torque receiving member comprises a generally elongate threaded rod.

10. The dental component of claim 1, wherein the dental component comprises a driver wherein the engagement portion of the driving member is configured for engagement with a rotary drill and wherein the torque receiving member comprises a male hex member.

11. The dental component of claim 1, wherein the dental component comprises a drill wherein the engagement portion of the driving member is configured for engagement with a rotary drill and the torque receiving member comprises a drill bit.

12. A cam screw for coupling an abutment to an implant comprising:
a driving component comprising an internal hex opening and a ball portion positioned generally below the driving component, the driving component and the ball portion generally extending along an elongate first axis, the ball portion comprising a pair of outer radial lobes and a central radial cam surface positioned therebetween, the radial lobes being positioned along a first pivot axis;
a sleeve socket comprising an interior portion and an exterior portion, the interior portion comprising a pair of radial pockets and a central radial cam surface positioned therebetween, the exterior portion comprising a pair of outer radial lobes and an outer radial cam surface positioned therebetween, the radial pockets of the interior portion being positioned along a second pivot axis and the radial lobes on the exterior portion being positioned along a third pivot axis, the second and third pivot axes being generally transverse relative to one another; and
an abutment screw extending along an elongate second axis and comprising a lower threaded portion, an upper head portion, and a medial portion positioned therebetween, the upper head portion comprising an outer socket having a pair of radial pockets and a central radial cam surface formed therein, the central radial cam surface being positioned between the radial pockets, the radial sockets being positioned along a fourth pivot axis.

13. The cam screw of claim 12, wherein the ball portion of the driving component removably couples to the interior portion of the sleeve socket such that the driving component is pivotable relative to the sleeve socket in a first direction but prohibited from pivoting in a second direction generally transverse to the first direction.

14. The cam screw of claim 13, wherein the exterior portion of the sleeve socket removably couples to the outer socket of the upper head portion of the abutment screw, the sleeve socket being pivotable relative to the outer socket in a third direction but prohibited from pivoting in a fourth direction generally transverse to the third direction.

15. The cam screw of claim 14, wherein the first direction is substantially similar to the fourth direction.

16. The cam screw of claim 14, wherein the second direction is substantially similar to the third direction.

17. The cam screw of claim 14, wherein the radial lobes of the ball portion are configured to pivotally couple to the radial pockets of the interior portion of the sleeve socket, the pivotable coupling therebetween defining a first collinear axis, the first collinear axis is defined by the first pivot axis of the radial lobes of the ball portion being axially aligned with the second pivot axis of the radial pockets.

18. The cam screw of claim 14, wherein the radial lobes of the sleeve socket are configured to pivotally couple to the radial pockets of the outer portion of the upper head portion of the abutment screw, the pivotable coupling therebetween defining a second collinear axis, the second collinear axis defined by the third pivot axis of the radial lobes being axially aligned with the fourth pivot axis of the radial pockets of the outer portion.

19. The cam screw of claim 18, wherein the first collinear axis is generally transverse the second collinear axis.

20. The cam screw of claim 18, wherein with the driving component coupled to the sleeve socket and the sleeve socket coupled to the abutment screw, rotation of the driving component causes rotation of the abutment screw in the same direction, and wherein the elongate first axis of the driving component can be offset at an angle relative to the elongate second axis of the abutment screw.

21. The cam screw of claim 20, wherein the elongate first axis can be offset at an angle relative to the elongate second axis between about 1-60 degrees.

22. A method of providing application of torque to a screw having a driving angle that is offset at an angle relative to the axis of the screw, the method comprising:
providing a driving component, the driving component extending along a first axis and comprising an internal hex opening and a ball portion positioned generally below the internal hex opening;
providing a sleeve socket, the sleeve socket comprising an interior portion and an exterior portion, the interior portion being configured for pivotally coupling to the ball portion;
providing an abutment screw, the abutment screw extending along a second axis and comprising a lower threaded portion and an upper head portion, the upper head portion comprising an outer socket, the outer socket configured for pivotally coupling to the exterior portion of the sleeve socket;
pivotally coupling the ball portion to the interior portion of the sleeve socket; and
pivotally coupling the exterior portion of the sleeve socket to the outer socket of the abutment screw,
wherein with the first axis being offset and an angle relative to the second axis, the driving component is capable of applying torque about the first axis in a first direction to cause torque to be applied to the abutment screw about the second axis in the first direction.

23. The method of claim 22, wherein the driving component is capable of applying torque about the first axis in a second direction to cause torque to be applied to the abutment screw about the second axis in the second direction, the second direction being generally opposite the first direction.

24. The method of claim 22, wherein the angle defined between the offset first and second axes is between about 1-60 degrees.
